(19) United States
(12) Patent Application Publication
(10) Pub. No.: US 2008/0012258 A1
(43) Pub. Date: Jan. 17, 2008

(54) Climate-control system for a perambulator, wheelchair, or the like

(76) Inventor: Hattie M. Townsend, Manhattan, NY (US)

Correspondence Address: CHARLES E. BAXLEY, ESQ., 90 JOHN STREET, THIRD FLOOR, NEW YORK, NY, 10038, US

(21) Appl. No.: 11/487,910

(22) Filed: Jul. 17, 2006

(51) Int. Cl. B62B 7/00

(52) U.S. Cl. 280/47.38

(57) ABSTRACT

A climate-control system for a perambulator, wheelchair, or the like. The climate-control system includes an enclosure and a climate-control unit. The enclosure is operatively connected to the perambulator, wheelchair, or the like, contains an environment, is completely sealed from the ambient so as to isolate the environment contained in the enclosure from the ambient, and encloses an occupant of the perambulator, wheelchair, or the like so as to isolate the occupant of the perambulator, wheelchair, or the like from the ambient. The climate-control unit is operatively connected to the enclosure and regulates the environment contained in the enclosure, as desired.

### 1. BACKGROUND OF THE INVENTION

A. Field of the Invention

The embodiments of the present invention relate to a climate-control system, and more particularly, the embodiments of the present invention relate to a climate-control system for a perambulator, wheelchair, or the like.

B. Description of the Prior Art

Babies and small children enjoy going for outings in strollers. These outings are beneficial in many ways. Outings stimulate children and provide care givers with needed exercise. Unfortunately, problems with sun, rain, wind, and insects can limit care givers from taking children for walks.

During an outing, the weather and the child's needs can change quickly. Children generally like to see as much of their surroundings as possible and object if their view is blocked. But if the child falls asleep during the outing, he may be disturbed by sun and movement around him. Rainstorms can come up suddenly and unexpectedly.

A major problem for children in strollers is sun exposure. This is particularly true between about 10 AM and 2 PM when the sun's radiation is strongest. Sun exposure has been increasingly recognized in recent years as a risk factor for skin cancer. Exposure to ultraviolet radiation is a particular risk. Skin cancer is an important public health problem. Studies estimate that 1 in 7 children will get skin cancer. Sunburns in childhood also greatly increase the risk of skin cancer. With the erosion of the ozone layer, sun exposure is expected to become an even greater hazard in the future.

Concerns about sun exposure can limit the hours when outings are possible to the early morning or late in the day. Given the tight schedules of many care givers, scheduling outings around limits like these is difficult. Small children have little concept of a future, and generally do not react well to having a walk postponed when they want to go outside now.

A stroller sunshade can be supplemented by draping a blanket over the sunshade framework in the direction from which the sun is shining. This provides more shade but blocks the child's view. The blanket tends to come loose and fall off, so that it must be rearranged frequently. The blanket must also be rearranged whenever the angle of the sun changes, as when a corner is turned. Blankets block air circulation.

Flying insects are another problem for children in strollers. Mosquitoes are a particular problem, but bees, wasps, and flies can also be annoying or even dangerous. Mosquito bites are irritating and can also spread disease. Bee and wasp stings are painful at best and can be life-threatening in children with allergies. Insect activity varies with the time of day and with proximity to breeding areas and the like. Mosquitoes, for example, breed in water and typically are most active in the evening. Mosquito activity can limit outings near lakes and other water sources. Mosquito activity may also further limit the times when outings are possible, in addition to the limits imposed by sun exposure.

Another problem for children in strollers is rain. Pushing a stroller generally requires two hands. It is therefore very difficult for a care giver to keep a child dry in a rainstorm, even if the care giver is equipped with an umbrella. A wet child is likely to be cold and cranky in all but the hottest weather. Possibilities for outings are therefore even more restricted when rain is predicted. In combination with the limits imposed by sun and insects, the result can be an unhappy child who rarely gets outside and a care giver who gets little exercise.

Numerous innovations for perambulator protectors have been provided in the prior art that will be described below in chronological order to show advancement in the art and which are incorporated herein by reference thereto. Even though these innovations may be suitable for the specific individual purposes to which they address, they each differ in structure, and/or operation, and/or purpose from the embodiments of the present invention in that they do not teach a climate-control system for a perambulator, wheelchair, or the like.

(1) U.S. Pat. No. 2,789,863 to Shimabukuro.

U.S. Pat. No. 2,789,863 issued to Shimabukuro on Apr. 23, 1957 in class 296 and subclass 78 teaches a protector for awning type baby strollers, including an enclosure formed from thin sheet material to provide vertical front, rear, and side walls with their upper edges disposed substantially in a common plane and connected along their vertical edges. The enclosure has a narrow panel extended rearwardly from the upper edge of the front wall in position to rest, and be supported on, the forward portion of the awning of the stroller, and the panel is connected at its end edges to adjacent upper edges of the respective side walls. The rear wall and the side walls are separated for a substantial distance downwardly from their upper edges to provide slots that may embrace the handle portions of the stroller. A second panel extends between the lower rear edges of the side walls and is connected to the lower edge of the rear wall in position to engage the rear edge of the back of the stroller when the back is lowered to thereby retain the rear wall in a protecting position. Cooperating fastening apparatus is at the opposed sides of the slots for securing the protector to the handle portion of the stroller.

(2) U.S. Pat. No. 3,834,756 to Grell.

U.S. Pat. No. 3,834,756 issued to Grell on Sep. 10, 1974 in class 296 and subclass 136 teaches a protective cover for a child's stroller, and which keeps the child from inclement weather and splashing from passing vehicles. The device is placable over, or else be built into, the canopy of a stroller, and includes transparent curtains depending downwardly around all sides of the stroller thus forming an umbrella-like enclosure that is open from underneath.

(3) U.S. Pat. No. 4,533,170 to Banks et al.

U.S. Pat. No. 4,533,170 issued to Banks et al. on Aug. 6, 1985 in class 296 and subclass 78 A teaches a self-supporting frame for a stroller or similar infant conveyance that is resiliently flexed into a deformed self-supporting configuration when installed on the infant conveyance and which when detached from the infant conveyance is collapsible into a compact bundle of elongated members.

(4) U.S. Pat. No. 4,949,740 to Friday.

U.S. Pat. No. 4,949,740 issued to Friday on Aug. 21, 1990 in class 135 and subclass 90 teaches an inclement weather protective hood device against weather conditions for wheelchair occupants. The device includes a symmetrical, collapsible, tubular, detachable structure covered by a two toned transparent plastic covering, clear in the front and sides, and tinted in the top and back. The two-toned covering permits a chair occupant to have good visibility and be seen more easily by pedestrians and vehicular traffic.

(5) U.S. Pat. No. 5,034,594 to Beezhold et al.

U.S. Pat. No. 5,034,594 issued to Beezhold et al on Jul. 23, 1991 in class 219 and subclass 528 teaches a seat cushion heated by an electrical resistance heating element sandwiched between two seat cushion sections is covered by a flexible sheet cover integral with two web projections projecting from an edge of the cushion and spaced-apart lengthwise of the cushion edge a distance for reception of a hand therebetween. A battery housing tube is elongated lengthwise of the cushion edge arranged substantially parallel thereto and has ears projecting from the side of the battery housing tube nearer the cushion and spaced-apart lengthwise of the tube a distance corresponding to the spacing of the web projections and secured to the web projections. A cap is for closing one end of the battery housing tube and openable for insertion of a battery into the housing tube and the other end of the housing tube is closed by a cover including a rotary switch for energizing the electrical resistance heating element by a battery in the battery housing tube.

(6) U.S. Pat. No. 5,897,162 to Humes et al.

U.S. Pat. No. 5,897,162 issued to Humes et al. on Apr. 27, 1999 in class 297 and subclass 180.12 teaches a child safety seat for a motor vehicle, having an independent heating arrangement and including a seat body with a seat portion, a backrest portion, and two side portions transverse to said seat and backrest portions. A child-receiving recessed area is formed by the seat, backrest, and side portions, with an insulating padding disposed therein. An electrical heating element is substantially disposed between the insulating padding and a protective cover substantially extending about at least the seat and backrest portions, so that in operation a substantial portion of the child-receiving recessed area is heated by the electrical heating element.

(7) U.S. Pat. No. 6,127,655 to Humes et al.

U.S. Pat. No. 6,127,655 issued to Humes et al. on Oct. 3, 2000 in class 219 and subclass 217 teaches a heated baby stroller, including a seat body including a seat portion and a backrest portion. A child-receiving recessed area is formed by the seat and backrest portions. An insulating padding is disposed within the child-receiving recessed area. An electrical heating element is substantially positioned between the insulating padding and a protective cover substantially extending about the seat and backrest portions. The electrical heating element is surrounded by an insulating layer, and a heating block is formed in such a manner that the padding and the insulating layer with the heating element are enveloped by a sheath.

(8) U.S. Pat. No. 6,217,099 to McKinney et al.

U.S. Pat. No. 6,217,099 issued to McKinney et al. on Apr. 17, 2001 in class 296 and subclass 77.1 teaches a multi-layer protective shield for a stroller, with an inflatable frame supporting a series of layers providing protection against sun, rain, wind, and insects. The protective shield includes at least two protective layers. At least one layer is resistant to UV radiation. The layers include a film layer adapted to protect a child seated in the stroller from rain. The film layer is resistant to UV radiation. At least one layer is a netting layer adapted to protect the child from flying insects. The protective layers may include an opaque layer composed of a flexible metalized plastic material. The inflatable frame and the layers each pivot with respect to the stroller. The protective layers are supported by the frame. One or more fans may be included to encourage air circulation.

(9) U.S. Pat. No. 6,224,073 to Au.

U.S. Pat. No. 6,224,073 issued to Au on May 1, 2001 in class 280 and subclass 47.38 teaches a collapsible wind screen assembly for an infant stroller or similar perambulator. The collapsible wind screen assembly includes two collapsible side panel members including loops made of resilient material, such as steel or the like, which act as frames for the wind screen, with nylon or mosquito netting material as a covering. Each side panel member is placed on either side of the stroller and secured to the stroller with fasteners, such as adhesive tape or laces. A cover member including flexible mesh or netting material covers the front and top of the assembly.

It is apparent that numerous innovations for perambulator protectors have been provided in the prior art that are adapted to be used. Furthermore, even though these innovations may be suitable for the specific individual purposes to which they address, they would not be suitable for the purposes of the embodiments of the present invention as heretofore described, namely, a climate-control system for a perambulator, wheelchair, or the like.

### 2. SUMMARY OF THE INVENTION

Thus, an object of the embodiments of the present invention is to provide a climate-control system for a perambulator, wheelchair, or the like that avoids the disadvantages of the prior art.

Briefly stated, another object of an embodiment of the present invention is to provide a climate-control system for a perambulator, wheelchair, or the like. The climate-control system includes an enclosure and a climate-control unit. The enclosure is operatively connected to the perambulator, wheelchair, or the like, contains an environment, is completely sealed from the ambient so as to isolate the environment contained in the enclosure from the ambient, and encloses an occupant of the perambulator, wheelchair, or the like so as to isolate the occupant of the perambulator, wheelchair, or the like from the ambient. The climate-control unit is operatively connected to the enclosure and regulates the environment contained in the enclosure, as desired.

The novel features which are considered characteristic of the embodiments of the present invention are set forth in the appended claims. The embodiments of the present invention themselves, however, both as to their construction and their method of operation, together with additional objects and advantages thereof, will be best understood from the following description of the specific embodiments when read and understood in connection with the accompanying drawing.

### 3. BRIEF DESCRIPTION OF THE DRAWING

The figures of the drawing are described as follows:

FIG. 1 is a diagrammatic perspective view of the climate-control system for a perambulator, wheelchair, or the like of the embodiments of the present invention;

FIG. 2 is an enlarged diagrammatic perspective view of the enclosure of the climate-control system for a perambulator, wheelchair, or the like of the embodiments of the present invention identified by ARROW 2 in FIG. 1; and

FIG. 3 is an enlarged diagrammatic perspective view of the climate-control unit of the climate-control system for a perambulator, wheelchair, or the like of the embodiments of the present invention identified by ARROW 3 in FIG. 1.

### 4. LIST OF REFERENCE NUMERALS UTILIZED IN THE DRAWING

### A. General.

10 climate-control system of embodiment of present invention for perambulator, wheelchair, or like 12
12 perambulator, wheelchair, or like
14 enclosure for operatively connecting to perambulator, wheelchair, or like 12 and for enclosing occupant of perambulator, wheelchair, or like 12 so as to isolate occupant of perambulator, wheelchair, or like 12 from ambient
16 climate-control unit

### B. Enclosure 14.

18 left side panel of enclosure 14 for securing to left side 24 of perambulator, wheelchair, or like 12 by adhesive tape, laces, strings, strips of fabric having hook and loop fasteners, or like
20 right side panel of enclosure 14 for securing to right side 26 of perambulator, wheelchair, or like 12 by adhesive tape, laces, strings, strips of fabric having hook and loop fasteners, or like
22 cover panel of enclosure 14 for covering top 28, front 30, bottom 32, and rear 34 of perambulator, wheelchair, or like 12
24 left side of perambulator, wheelchair, or like 12
26 right side of perambulator, wheelchair, or like 12
28 top of perambulator, wheelchair, or like 12
30 front of perambulator, wheelchair, or like 12
32 bottom of perambulator, wheelchair, or like 12
34 rear of perambulator, wheelchair, or like 12
36 edges of left side panel 18 of enclosure 14
38 edges of right side panel 20 of enclosure 14
40 edges of cover panel 22 of enclosure 14

### C. Climate-Control Unit 16.

42 main housing of climate-control unit 16 for access by pusher of perambulator, wheelchair, or like 12
44 cooling module of climate-control unit 16
46 heating module of climate-control unit 16
48 humidifying module of climate-control unit 16
50 dust filter module of climate-control unit 16
52 pollen filter module of climate-control unit 16
54 main control panel of climate-control unit 16
56 rear wall of main housing 42 of climate-control unit 16
58 secondary housing of climate-control unit 16 for disposing within enclosure 14
60 secondary control panel of climate-control unit 16 for allowing occupant of perambulator, wheelchair, or like 12 to operate climate-control unit 16 from within enclosure 14

### 5. DETAILED DESCRIPTION OF THE PREFERRED EMBODIMENTS

### A. General.

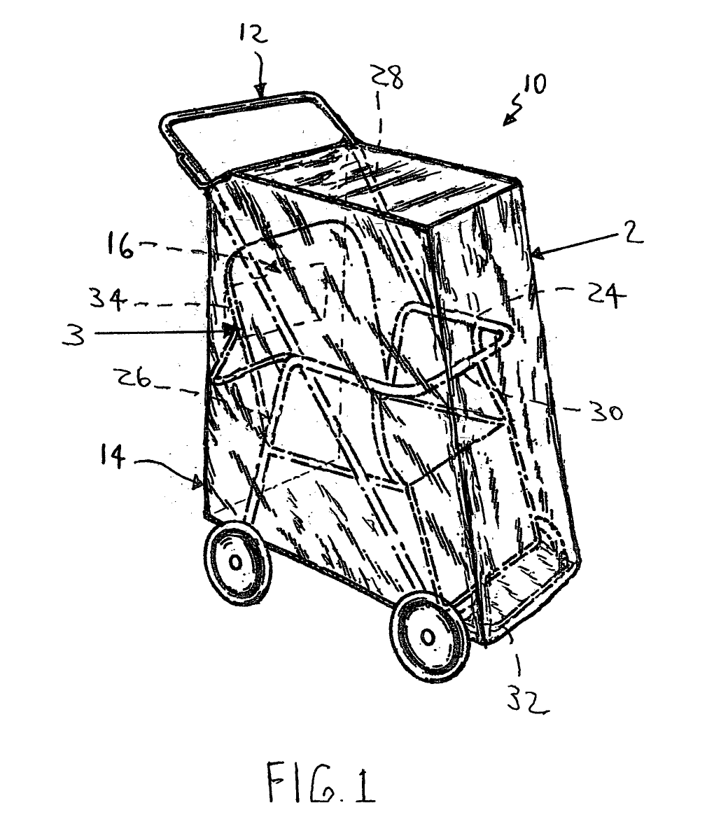

Referring now to the figures in which like numerals indicate like parts, and particularly to FIG. 1, which is a diagrammatic perspective view of the climate-control system for a perambulator, wheelchair, or the like of the embodiments of the present invention, the climate-control system of an embodiment of the present invention is shown generally at 10 for a perambulator, wheelchair, or the like 12.

The climate-control system 10 comprises an enclosure 14 and a climate-control unit 16. The enclosure 14 is for operatively connecting to the perambulator, wheelchair, or the like 12, contains an environment, is completely sealed from the ambient so as to isolate the environment contained in the enclosure 14 from the ambient, and is for enclosing an occupant of the perambulator, wheelchair, or the like 12 so as to isolate the occupant of the perambulator, wheelchair, or the like 12 from the ambient. The climate-control unit 16 is operatively connected to the enclosure 14 and regulates the environment contained in the enclosure 14, as desired.

### B. The Enclosure 14.

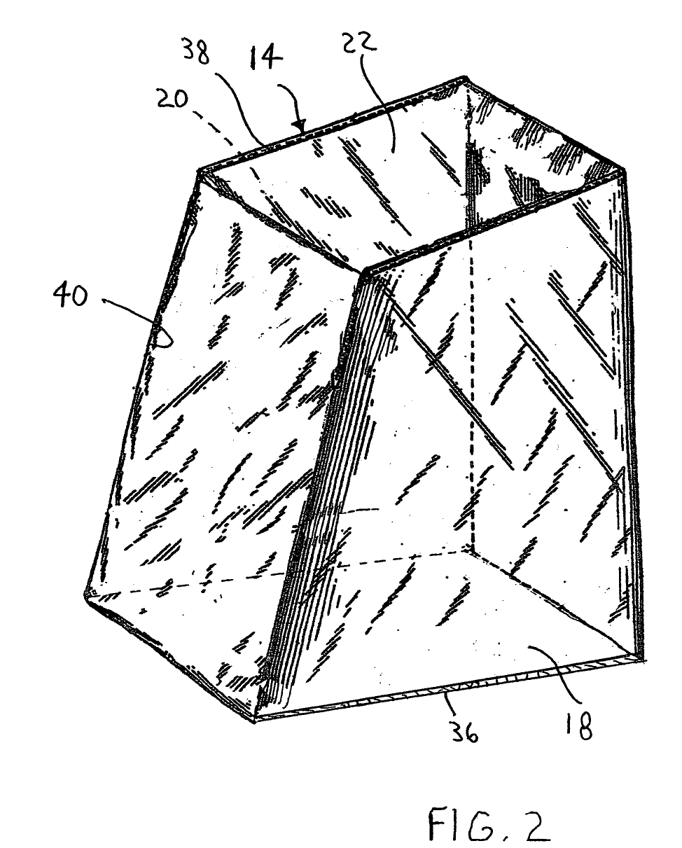

The configuration of the enclosure 14 can best be seen in FIG. 2, which is an enlarged diagrammatic perspective view of the enclosure of the climate-control system for a perambulator, wheelchair, or the like of the embodiments of the present invention identified by ARROW 2 in FIG. 1, and as such, will be discussed with reference thereto.

The enclosure 14 comprises a left side panel 18, a right side panel 20, and a cover panel 22, and as shown in FIG. 1, the perambulator, wheelchair, or the like 12 has a left side 24, a right side 26, a top 28, a front 30, a bottom 32, and a rear 34.

The left side panel 18 of the enclosure 14 has edges 36, and is for securing to the left side 24 of the perambulator, wheelchair, or the like 12 by adhesive tape, laces, strings, strips of fabric having hook and loop fasteners, or the like. The right side panel 20 of the enclosure 14 has edges 38, and is for securing to the right side 26 of the perambulator, wheelchair, or the like 12 by adhesive tape, laces, strings, strips of fabric having hook and loop fasteners, or the like. The cover panel 22 of the enclosure 14 has edges 40, and is for covering the top 28, the front 30, the bottom 32, and the rear 34 of the perambulator, wheelchair, or the like 12.

The left side panel 18 of the enclosure 14 is made from a resilient material, such as flexible plastics, such as polyvinyl chloride films, flexible thermoplastic sheets, such as transparent polyolefins, shape memory alloys, such as Flexon, RTM, or combinations thereof, and is sheathed in a flexible sheet or web, such as cloth or a plastic sheet, so as to be resistant to rain, UV radiation, or the like, or alternatively is dip-coated with a molten thermoplastic material that cools to form an adherent coating.

The right side panel 20 of the enclosure 14 is made from a resilient material, such as flexible plastics, such as polyvinyl chloride films, flexible thermoplastic sheets, such as transparent polyolefins, shape memory alloys, such as Flexon, RTM, or combinations thereof, and is sheathed in a flexible sheet or web, such as cloth or a plastic sheet, so as to be resistant to rain, UV radiation, or the like, or alternatively is dip-coated with a molten thermoplastic material that cools to form an adherent coating.

The cover panel 22 of the enclosure 14 is made from a resilient material, such as flexible plastics, such as polyvinyl chloride films, flexible thermoplastic sheets, such as transparent polyolefins, shape memory alloys, such as Flexon, RTM, or combinations thereof, and is sheathed in a flexible sheet or web, such as cloth or a plastic sheet, so as to be resistant to rain, UV radiation, or the like or alternatively is dip-coated with a molten thermoplastic material that cools to form an adherent coating.

The edges 40 of the cover panel 22 of the enclosure 14 are attached to the edges 36 of the left side panel 18 of the enclosure 14 and the edges 38 of the right side panel 20 of the enclosure 14, either permanently by stitches, adhesive, or the like, or removably by mating zippers, hook and loop fasteners, or the like, allowing the cover panel 22 of the enclosure 14 to be separated from the left side panel 18 of the enclosure 14 and the right side panel 20 of the enclosure 14 for storing separately.

### C. The Climate-Control Unit 16.

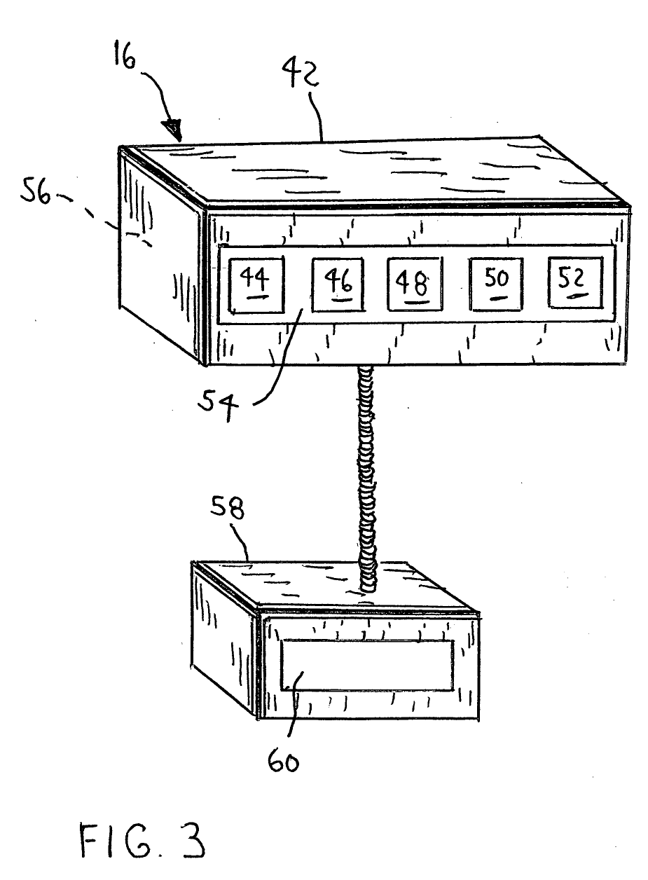

The configuration of the climate-control unit 16 can best be seen in FIG. 3, which is an enlarged diagrammatic perspective view of the climate-control unit of the climate-control system for a perambulator, wheelchair, or the like of the embodiments of the present invention identified by ARROW 3 in FIG. 1, and as such, will be discussed with reference thereto.

The climate-control unit 16 comprises a main housing 42, a cooling module 44, a heating module 46, a humidifying module 48, a dust filter module 50, a pollen filter module 52, and a main control panel 54.

The main housing 42 of the climate-control unit 16 has a rear wall 56 positioned on the cover panel 22 of the enclosure 14 at the rear 34 of the perambulator, wheelchair, or the like 12, for allowing access of the main housing 42 of the climate-control unit 16 by a pusher of the perambulator, wheelchair, or the like 12.

The rear wall 56 of the main housing 42 of the climate-control unit 16 communicates with the cover panel 22 of the enclosure 14 so as to allow the climate-control unit 16 to regulate the environment contained in the enclosure 14, as desired.

The cooling module 44 of the climate-control unit 16 is disposed in the main housing 42 of the climate-control unit 16 and cools, on-demand, the environment contained in the enclosure 14.

The heating module 46 of the climate-control unit 16 is disposed in the main housing 42 of the climate-control unit 16 and heats, on-demand, the environment contained in the enclosure 14.

The humidifying module 48 of the climate-control unit 16 is disposed in the main housing 42 of the climate-control unit 16 and humidifies/dehumidifies, on-demand, the environment contained in the enclosure 14.

The dust filter module 50 of the climate-control unit 16 is disposed in the main housing 42 of the climate-control unit 16 and filters dust, on-demand, from the environment contained in the enclosure 14.

The pollen filter module 52 of the climate-control unit 16 is disposed in the main housing 42 of the climate-control unit 16 and filters pollen, on-demand, from the environment contained in the enclosure 14.

The main control panel 54 of the climate-control unit 16 is disposed on the main housing 42 of the climate-control unit 16 and selectively operates the cooling module 44, the heating module 46, the humidifying module 48, the dust filter module 50, and the pollen filter module 52 of the climate-control unit 16.

The climate-control unit 16 further comprises a secondary housing 58 and a secondary control panel 60. The secondary housing 58 of the climate-control unit 16 is for disposing within the enclosure 14. The secondary control panel 60 of the climate-control unit 16 is disposed on the secondary housing 58 of the climate-control unit 16 and is operatively connected to the main control panel 54 of the climate-control unit 16 for allowing the occupant of the perambulator, the wheelchair, or the like 12 to operate the climate-control unit 16 from within the enclosure 14.

### D. Conclusions.

It will be understood that each of the elements described above, or two or more together, may also find a useful application in other types of constructions differing from the types described above.

While the embodiments of the present invention have been illustrated and described as embodied in a climate-control system for a perambulator, wheelchair, or the like, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can, by applying current knowledge, readily adapt them for various applications without omitting features that, from the standpoint of prior art, fairly constitute characteristics of the generic or specific aspects of the embodiments of the present invention.

The invention claimed is:

1. A climate-control system for a perambulator or a wheelchair, comprising:
a) an enclosure; and
b) a climate-control unit;
wherein said enclosure is for operatively connecting to the perambulator or the wheelchair;
wherein said enclosure contains an environment;
wherein said enclosure is completely sealed from the ambient so as to isolate said environment contained in said enclosure from the ambient;
wherein said enclosure is for enclosing an occupant of the perambulator or the wheelchair so as to isolate the occupant of the perambulator or the wheelchair from the ambient;
wherein said climate-control unit is operatively connected to said enclosure; and
wherein said climate-control unit regulates said environment contained in said enclosure, as desired.

2. The system of claim 1, wherein said enclosure comprises a left side panel;
wherein said enclosure comprises a right side panel;
wherein said enclosure comprises a cover panel;
wherein the perambulator or the wheelchair has a left side;
wherein the perambulator or the wheelchair has a right side;
wherein the perambulator or the wheelchair has a top;
wherein the perambulator or the wheelchair has a front;
wherein the perambulator or the wheelchair has a bottom;
wherein the perambulator or the wheelchair has a rear;
wherein said left side panel of said enclosure is for securing to the left side of the perambulator or the wheelchair;
wherein said right side panel of said enclosure is for securing to the right side of the perambulator or the wheelchair; and
wherein said cover panel of said enclosure is for covering the top, the front, the bottom, and the rear of the perambulator or the wheelchair.

3. The system of claim 2, further comprising means for securing said left side panel and said right side panel to the left side and the right side of the perambulator or the wheelchair, respectively.

4. The system of claim 3, wherein said means is selected from the group consisting of adhesive tape, laces, strings, and strips of fabric having hook and loop fasteners.

5. The system of claim 2, wherein said left panel, said right panel, and said cover of said enclosure are made from a resilient material that is rain and UV radiation resistant.

6. The system of claim 5, wherein said resilient material is sheathed in a flexible sheet or web.

7. The system of claim 6, wherein said flexible sheet or web is selected from the group consisting of a cloth sheet and a plastic sheet.

8. The system of claim 6, wherein said resilient material is dip-coated with a molten thermoplastic material that cools to form an adherent coating.

9. The system of claim 5, wherein said resilient material is selected from the group consisting of flexible plastics, polyvinyl chloride films, flexible thermoplastic sheets, transparent polyolefins, shape memory alloys, and combinations thereof.

10. The system of claim 2, wherein said cover panel of said enclosure has edges;
wherein said left side panel of said enclosure has edges;
wherein said right side panel of said enclosure has edges; and
wherein said edges of said cover panel of said enclosure are attached to said edges of said left side panel of said enclosure and said edges of said right side panel of said enclosure.

11. The system of claim 10, wherein said edges of said cover panel of said enclosure are attached to said edges of said left side panel of said enclosure and said edges of said right side panel of said enclosure permanently by means selected from the group consisting of stitches and adhesive.

12. The system of claim 10, wherein said edges of said cover panel of said enclosure are attached to said edges of said left side panel of said enclosure and said edges of said right side panel of said enclosure removably by means selected from the group consisting of mating zippers and hook and loop fasteners allowing said cover panel of said enclosure to be separated from said left side panel of said enclosure and said right side pane of said enclosure for storing separately.

13. The system of claim 2, wherein said climate-control unit comprises a main housing;
wherein said climate-control unit comprises a cooling module;
wherein said climate-control unit comprises a heating module;
wherein said climate-control unit comprises a humidifying module;
wherein said climate-control unit comprises a dust filter module;
wherein said climate-control unit comprises a pollen filter module; and
wherein said climate-control unit comprises a main control panel.

14. The system of claim 13, wherein said main housing of said climate-control unit is for accessing by a pusher of the perambulator or the wheelchair;
wherein said main housing of said climate-control unit has a rear wall;
wherein said rear wall of said main housing of said climate-control unit is positioned on said cover panel of said enclosure, at the rear of the perambulator or the wheelchair; and
wherein said rear wall of said main housing of said climate-control unit communicates with said cover panel of said enclosure so as to allow said climate-control unit to regulate said environment contained in the enclosure, as desired.

15. The system of claim 13, wherein said cooling module of said climate-control unit is disposed in said main housing of said climate-control unit; and
wherein said cooling module of said climate-control unit cools, on-demand, said environment contained in said enclosure.

16. The system of claim 13, wherein said heating module of said climate-control unit is disposed in said main housing of said climate-control unit; and
wherein said heating module of said climate-control unit heats, on-demand, said environment contained in said enclosure.

17. The system of claim 13, wherein said humidifying module of said climate-control unit is disposed in said main housing of said climate-control unit; and
wherein said humidifying module of said climate-control unit humidifies/dehumidifies, on-demand, said environment contained in said enclosure.

18. The system of claim 13, wherein said dust filter module of said climate-control unit is disposed in said main housing of said climate-control unit; and
wherein said dust filter module of said climate-control unit filters dust, on-demand, from said environment contained in said enclosure.

19. The system of claim 13, wherein said pollen filter module of said climate-control unit is disposed in said main housing of said climate-control unit; and
wherein said pollen filter module of said climate-control unit filters pollen, on-demand, from said environment contained in said enclosure.

20. The system of claim 13, wherein said main control panel of said climate-control unit is disposed on said main housing of said climate-control unit; and
wherein said main control panel of said climate-control unit selectively operates said cooling module, said heating module, said humidifying module, said dust filter module, and said pollen filter module of said climate-control unit.

21. The system of claim 13, wherein said climate-control unit comprises a secondary housing;
wherein said climate-control unit comprises a secondary control panel;
wherein said secondary housing of said climate-control unit is for disposing within said enclosure;
wherein said secondary control panel of said climate-control unit is disposed on said secondary housing of said climate-control unit; and
wherein said secondary control panel of said climate-control unit is operatively connected to said main control panel of said climate-control unit for allowing the occupant of the perambulator or the wheelchair to operate said climate-control unit from within said enclosure.
